(19) United States
(12) Patent Application Publication
(10) Pub. No.: US 2006/0236239 A1
(43) Pub. Date: Oct. 19, 2006

(54) Text entry system and method

(75) Inventors: Todd Garrett Simpson, Calgary (CA); Weigen Qiu, Calgary (CA)

Correspondence Address: HODGSON RUSS LLP, ONE M & T PLAZA, SUITE 2000, BUFFALO, NY, 14203-2391, US

(73) Assignee: ZI CORPORATION, Calgary (CA)

(21) Appl. No.: 10/561,653

(22) PCT Filed: Jun. 18, 2004
(86) PCT No.: PCT/CA04/00898

§ 371 Date: Jun. 2, 2006

Related U.S. Application Data
(60) Provisional application No. 60/479,055, filed on Jun. 18, 2003.

(51) Int. Cl. G06F 17/00

(52) U.S. Cl. 715/531

(57) ABSTRACT

A system and a method for text entry is disclosed. Each may be practiced using a single finger or thumb to create, select and enter characters or character sequences. The invention may be broadly applicable to the entry of a text object or a text string which may be created or received, stored, edited or transmitted by a personal appliance having a limited user interface, such as a reduced keypad or no keypad. The invention may be particularly useful in conjunction with an ideographic language.

### CROSS-REFERENCE TO RELATED APPLICATION

This application claims the benefit of priority to pending U.S. provisional patent application Ser. No. 60/479,055 filed on Jun. 18, 2003.

### FIELD OF THE INVENTION

This invention relates to entering text, and in particular to entering text on devices where a physical keypad is not provided or where access to a virtual keypad compromises the available screen display area for the created text. Such devices may include mobile personal appliances, such as cellular telephones (cell phones) or personal digital assistants (PDAs).

### BACKGROUND OF THE INVENTION

Creating text on mobile personal appliances has been done in a number of ways. For example, small keypads with layouts that are very similar to large keyboards have been created. Some of these have been sculpted for ease of use, such as found on the Blackberry™ personal messaging device.

In the PDA arena, virtual keypads have been used. Often virtual keypads will replicate the action of pressing a key by using a touch screen and a stylus. In most PDAs, the touch screen is large enough to accommodate displaying both the virtual keypad and the created text.

In the cell phone arena, keypads having a plurality of keys are often provided. Usually, a plurality of the keys are associated with text characters, such as letters, punctuation elements and/or numbers. For example, in a customary arrangement, eight of the keys are each associated with a different group of text characters, each group comprising three or four letters and one number. For example, one of the keys may have the number 2 and the letters A, B and C associated with that key. Disambiguating algorithms and/or other keys on the cell phone may be used to distinguish between text characters assigned to a key, and thereby allow the user to enter text.

In the ideographic space, for the Chinese and Japanese language in particular, the O'Dell patent (U.S. Pat. No. 5,109,352) teaches a method of categorizing the strokes used to build up characters. An algorithm may be used to determine which of a plurality of characters is intended by the user. There are implementations of this technology in the cellphone market, although the original patent was devised around a more traditional environment. One such commercial offering is eZiText™ from Zi Corporation wherein categorical stroke groupings are marked on and assigned to many of the keys forming the traditional telephone pushbutton keypad. While in the text creation mode, pressing a key results in a stroke being entered to a memory buffer, the stroke being selected from a category of strokes. After each button push, the stroke category is added to a display line that represents the stroke entry history, and a second character candidate line displays characters that contain strokes from the selected categories. The character candidates may be displayed in a way that optimizes the probability that a displayed candidate character is the character intended by the user.

Another example of entering ideographic text maybe found in the work of Carmon (U.S. Pat. No. 4,937,745) who demonstrates using standard stroke writing order to access characters in ideographic languages. Because this work was entirely based on a large computing environment, the use of categorization is relatively incidental since there was no essential requirement to save on keys or screen space.

In situations where physical or virtual keys are not available, the foregoing methods alone may be insufficient. Macor (U.S. Pat. No. 5,841,849) and others teach the use of a joystick or pointing device to select from a virtual keypad. The virtual keypad contents are contextual and variable in accordance with the particular operational mode of the device being operated. Using such a system, a cell phone or other mobile device may be controlled entirely with the pointing device.

### SUMMARY OF THE INVENTION

An embodiment of the invention is a text entry system that has a display, an indicator system, a processor and a processor control program. The program may control the processor so that text may be entered and displayed on the display in response to a user selecting options via the indicator system.

The display may be visually divided into at least two functional areas. The first of the functional areas may be used to display information corresponding to a first aspect of entering text, and a second of the functional areas may be used to display information corresponding to a second aspect of entering text. For example, the first aspect of entering text may be a list of candidate characters having features identified by the user. The second aspect of entering text may be a list of characters that the user has identified as being those she has entered. When the user finishes identifying characters, the result may be that a word or sentence appears in the second functional area.

The indicator system may be operable by one human digit, such as a finger or thumb. The indicator system may include a position indicator, for example, a joystick. Other indicator systems are possible, and some of those are described herein.

The indicator system may have at least a first cardinal state, a second cardinal state and a third cardinal state. In an embodiment of the invention, the third cardinal state may have no textual meaning associated with it. The first cardinal state may be activated by applying a force in a first location and the second cardinal stated may be activated by applying a force in a second location. The third cardinal state may be activated by identifying a third location. The third location may be identified by applying no force to the indicator system, or may be identified by applying a force to the third location. The third location may be located between the first location and the second location, so as to centrally locate the third location. A fourth cardinal state may be activated by activating both the first cardinal state and the third cardinal state.

The processor may be responsive to each cardinal state. In this fashion, the indicator system may be used to select options displayed in at least one of the functional areas. For example, the user may select a text character that is displayed in the first functional area, and thereby select that character for display in the second functional area. Further, the user may select a text character in the second functional area in order to edit the group of text characters appearing in the second functional area.

An embodiment of a text entry system according to the invention may have a first mode and a second mode. Moving from the first mode to the second mode may be accomplished by applying a force to the third location. When the text entry system is in the first mode, the first cardinal state may have a particular textual meaning associated with it. When the text entry system in the second mode, the first cardinal state may have a different meaning associated with it. The different meaning may be a different textual meaning, or the different meaning may have no textual meaning, for example, the different meaning may be a navigational meaning. Such a navigational meaning may be used to move a cursor appearing on the display.

In an embodiment of the text entry system, the first cardinal state may be used to select a first category of text and the second cardinal state may be used to select a second category of text. The first category of text may include text symbols, such as strokes, having a first feature and the second category of text may include text symbols having a second feature. For example the first category of text may include strokes that are drawn by hand using a vertical motion, while the second category of text may include strokes that are drawn by hand using a horizontal motion. Some symbols may have features of more than one category, in which case, the symbol may be associated with more than one category.

A method according to the invention may be a method of entering text. Such a method may provide 300 a display having a first functional area and a second functional area, provide 303 an indicator system having a first cardinal state, a second cardinal state and a third cardinal state, and provide 306 a processor operably connected to the indicator system. The first cardinal state may be activated 309 to indicate to the processor selection of a first category of text to be entered. The first category may include symbols used to create a plurality of text characters. A representative symbol corresponding to the first category may be displayed. A text character having one of the symbols corresponding to the selected first category may be displayed in the first functional area.

The second cardinal state may be activated to indicate to the processor selection of a second category of text to be entered. As a result, a text character having both one of the symbols corresponding to the first category and also one of the symbols corresponding to the second category may be displayed in the first functional area.

Once text characters are displayed in the first functional area, the user may desire entry of one of the displayed candidate text characters. The user may enter the navigational mode, and automatically have a cursor presented in the first functional area. Selecting a desired candidate text character may be accomplished by moving the cursor, by activating one or more of the cardinal states, so that the desired candidate character is identified. Having identified a candidate character, the user may then select that candidate character. Once a candidate text character is selected from the first functional area, the selected text character may be displayed in the second functional area to indicate to the user that that text character has been entered.

In an embodiment of the invention, the first functional area may be used to display not only text characters, but also portions of characters. These portions may be identical to text characters—that is to say that a particular icon may include the same strokes and appear in the first functional area twice, once as a text character that may be selected for display in the second functional area, and once as a portion of a character that may be selected for display in an area that is not the first functional area or the second functional area. If selected for display in an area that is not the first functional area or the second functional area, the user may be permitted to identify additional strokes that also correspond with the desired text character.

### DRAWINGS

For a fuller understanding of the nature and objects of the invention, reference should be made to the following detailed description taken in conjunction with the accompanying drawings, in which:

FIG. 1(a) shows a joystick having four cardinal states and a central state. Since the joystick of FIG. 1(a) may be moved, these states are often referred to herein as positions, to take account of the fact that the joystick may be moved to a particular position, and thereby cause the corresponding cardinal state to occur. Displacement of the joystick in one of the four cardinal positions may have a meaning assigned to it. In this example, these meanings may be categorical. The category 112 identified by the North cardinal position may mean all stroke structures having one or more distinct points of inflexion. The category 108 identified by the South cardinal position may mean all strokes that are vertical or nearly so. In general, this could include vertical strokes that, when written, might exhibit a tick mark at the bottom of the stroke. This is an artifact of writing with a brush and has found its way into ideograph structures.

FIG. 1(b) shows an electrical mechanism of a pointing device. Switches 105, 109, 113 and 117 may be closed in response to the movement of the joystick and have a meaning corresponding to the categories shown in FIG. 1(a). An additional switch, herein referred to as the “coaxial switch,” may be actuated by the application of coaxial pressure to the joystick may allow the sensing of a meaning or mode change. Coaxial pressure may be applied by applying a force on the joystick that is coaxial with a primary axis of the joystick. Such a force is sometimes referred to herein as a coaxial force or as coaxially pressing, or similar variations. The primary axis of the joystick may be an axis which is centrally located within the joystick and along its length. The four directional sensing switches may be used in combination with the coaxial switch.

FIG. 2 illustrates displayed information pertinent to an example. Window 200 shows a text creation area, window 212 shows contents of the entry buffer corresponding to entered stroke categories, and, where appropriate, any intermediate combinational results. Window 220 displays candidates resulting from the entered sequence of stroke categories.

FIG. 3 is a schematic flow diagram of a method according to the invention.

### DETAILED DESCRIPTION

The detailed description begins with a general discussion of some of the aspects of the invention. This general discussion is followed by a more detailed description, which makes frequent references to the drawings.

The invention may be implemented by using an indicator system which is operable by one finger, for example, a joystick. The indicator system may be comprised of a number of multidimensional actuators so long as there are discrete positions that can be used to represent a button push or its equivalent. For example, a continuous digitizer may be used along with software or hardware threshold detectors that determine selections desired by the user.

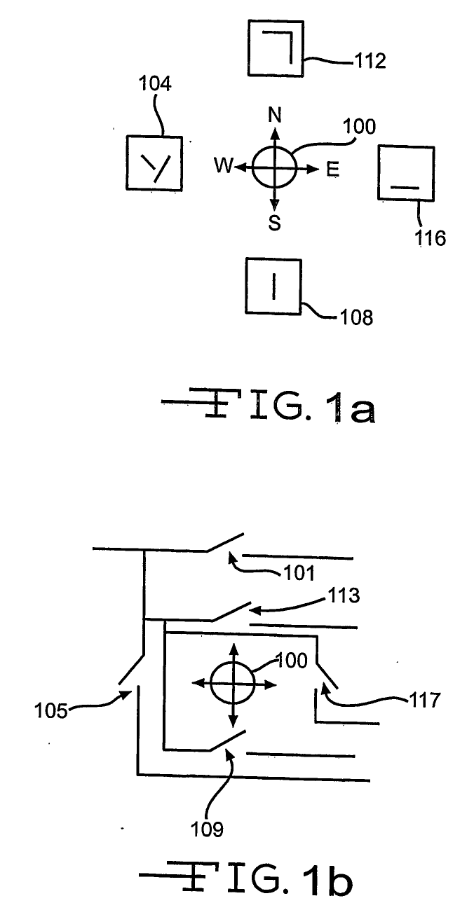

The invention is illustrated herein by describing a joystick indicator system. The joystick indicator system is described as having four discrete cardinal positions, each having a separate contact closure interpretation, and a central position wherein no contact closures are intended unless the joystick is pressed in a direction that is substantially coaxial with a primary axis of the joystick. When the joystick is coaxially pressed, a fifth contact closure interpretation is achieved. For ease of description, the four cardinal positions are referred to herein as North, South, East and West, although the cardinal positions need not actually be oriented in those directions. In FIG. 1(a) North is indicated by an “N”, South is indicated by an “S”, East is indicated by an “E” and West is indicated by a “W”. The invention is not limited to this arrangement or limited to this number of positions.

Each of the cardinal positions may be assigned a categorical meaning and a navigational meaning. When a device is set in a first mode, a particular categorical meaning may be selected by moving the joystick to the corresponding cardinal position. The first mode is sometimes referred to herein as the “categorical mode.” When the device is set in a second mode, the navigational meaning of that same cardinal position may be selected by moving the joystick to the same cardinal position. The second mode is sometimes referred to herein as the “navigational mode.”

For example, when in the first mode and therefore selecting a categorical meaning, moving the joystick to the East cardinal position may cause the category associated with the East cardinal position to be entered to a stroke entry memory buffer. However, when in the second mode and therefore selecting a navigational meaning, moving the joystick to the East cardinal position may cause a cursor to move on a display screen to the right.

By providing navigational ability, the user may be able to select from a group of candidate characters displayed on the screen. When in the navigational mode, moving the joystick to the East or West cardinal positions may cause a cursor to move over the candidate characters until the desired character is highlighted. Once highlighted, a coaxial press of the joystick may be made, in order to select that character to a text creation line.

In an embodiment of the invention, the navigational mode may be entered at any time. Even when the first mode has not been used to identify a desired categorical meaning, the user may enter the navigational mode, although this may be a less efficient way to find a desired character.

Once a character has been selected, a processor may execute an algorithm which predicts what the user might desire to enter next, so as to provide a list of associated candidate characters that the user may choose from. The associated candidate characters might be those that the algorithm predicts should reasonably follow the selected character in order to make up a word or a phrase. By displaying these associated candidate characters, the user may select one associated candidate character while still in the navigational mode, and thereby avoid needing to return to the categorical mode to identify the next categorical meaning.

In an embodiment of the invention, the user may move from the categorical mode to the navigational mode by indicating the central cardinal position, for example, by coaxially pressing the joystick. Moving from the navigational mode to the categorical mode may be achieved by moving the joystick in a direction that is not East or West, for example moving the joystick North. In this fashion, the user may move between the categorical and the navigational modes until the user has entered the desired text.

Transitioning now from the general description to a more detailed description, it should be noted that the following description sets forth how the invention might be employed on a cell phone, which is equipped with an indicator system that is a joystick. However, it must be recognized the invention is not limited to cell phones and the invention is not limited to joysticks. The invention may be implemented on a device other than a cell phone, and the invention may be implemented with indicator systems other than a joystick. For example, one alternative indicator system includes a set of keys arranged so that four keys surround a central fifth key. The surrounding four keys may be used to select the North, South, East or West cardinal positions, and the fifth key may be used to indicate an action associated with the central cardinal position. Although such an embodiment of the invention has the disadvantage of requiring the user to lift his finger in order to enter text, it is representative of an indicator system that could be employed to practice the invention.

FIG. 1(a) shows one possible layout with one of many possible maps between categorical meaning and position. The joystick 100 may be movable in the directions of the arrows. In this example, referring to FIG. 1(b), movement to the East closes switch 117, movement South closes switch 109, movement West closes switch 105 and movement North closes switch 113. Not shown quite as illustratively in FIG. 1(b) is a switch 101 that is actuated by coaxial pressure on the joystick 100. It should be clear that any of a number of schemes may be used to discern the user's intent of pointing. For example, if a force transducer is employed, physical movement of the joystick 100 need not occur in order for the user to identify the North, South, East and West cardinal positions.

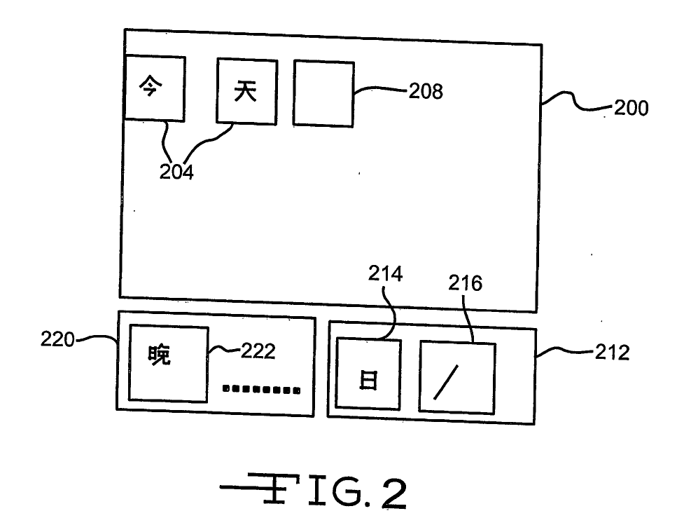

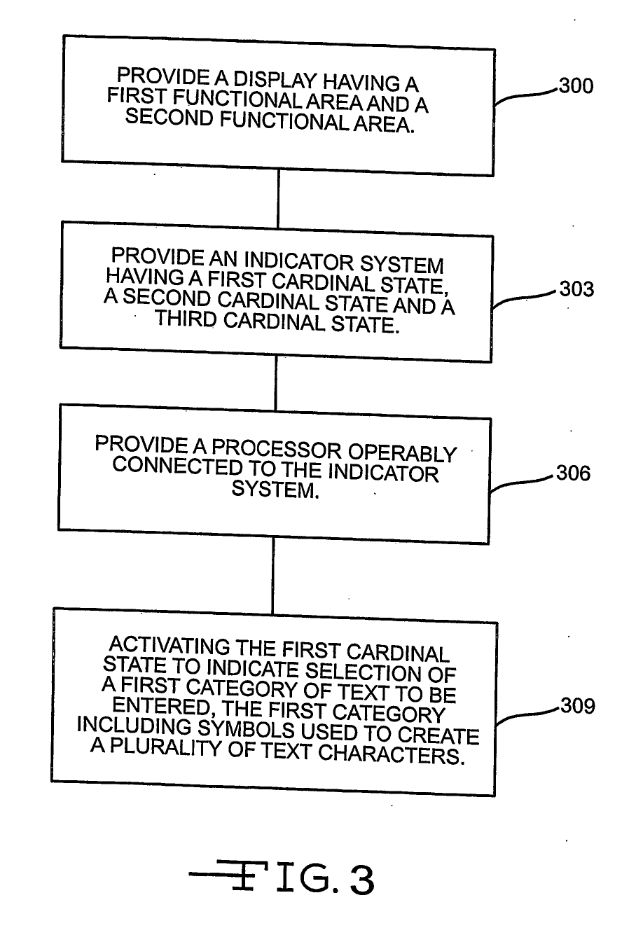

In the present example, because we have defined only four discrete positions for the pointing device, we will limit the description for simplicity and define only four categories of stroke elements. It should be noted that more or less than four cardinal positions may be employed, and any particular cardinal position may be used to identify more than one stroke element category. Each category may represent a group of strokes which share one or more characteristics. For example in FIG. 2, stroke category 104 may include stroke forms which when drawn by hand in the course of writing a hanzi (Chinese) character are normally completed in one motion beginning at the top of the writing area and continuing smoothly down to the left. In this example, no distinction has been made with regard to the size or length of the stroke when drawn, nor to the degree of slope of the element nor its position within any complete character.

Stroke category 108 may include substantially vertical strokes which start at the top of the writing area and are normally drawn smoothly to the bottom regardless of size or position in the character. In an embodiment of the invention, this category 108 may also include strokes which are concluded by lifting the brush from the paper with an upward flick resulting in an artifact of the writing resembling a tick mark.

Stroke category 112 may include strokes which turn distinctly when drawn. These strokes may have single or multiple inflection points and may not be smooth in appearance. Stroke category 116 may include strokes which are substantially horizontal in nature. In Chinese, these strokes are normally drawn by hand from left to right. Stroke category 116 may include some strokes which have a rising characteristic sloping slightly up to the right. The category 116 may also include dots, which may have any perceived directional characteristic.

The example given above is for illustration, and is not intended to limit the types of stroke categories that may be employed. Further, some strokes may be entered in more than one category, for example, when a stroke has characteristics of two categories. Moreover it may be possible to make one category “smart” so that selecting that category would allow a computer to assume that a stroke from any category had been entered. It should be clear that choosing the “smart” category may result in a list of candidate characters that is extensive.

FIG. 2 shows a display divided into three sections: (1) the main text area 200, in which entered text characters are shown, (2) the stroke display area 212, which may show a symbol corresponding to the category, or a representative stroke from that category, entered by the user, and (3) the candidate character area 220, which may show completed characters that have strokes associated with the categories identified in the stroke display area 212. In FIG. 2, we have chosen to show representative strokes, rather than using the category symbols shown in FIG. 1(a).

The display area may be limited in size, and not all items may be shown at the same time. For example, when a candidate character list is very long, portions of the candidate character list may be shown at the same time. In such cases, it may be helpful to consider the various areas as windows that allow viewing of parts of a list. It may be possible to allow a user to select which parts of a list are viewed, for example, by scrolling through the list using a cursor that is controlled by the user.

Feature number 204 identifies two characters already entered by the user and selected to the main text area 200. Feature number 208 shows the position where the next selected character will be entered on the main text area 200. The user may move the joystick 100 to the cardinal position associated with the category 104 in FIG. 1A. Such movement of the joystick 100 closes switch 105 and signals the processor to take category 104 as an input and display a representative stroke 216 in the stroke display area 212.

Once category 104 is identified, the processor may search a database for candidate characters that have a stroke that is in category 104. When the processor finds candidate characters, those candidate characters may be displayed in the candidate character area 220. Feature number 222 identifies one such candidate character. For ease of illustration, only one candidate character is shown in the area 220. The processor may display candidate characters in an order according to an ordering rubric. Such an ordering rubric might display the most often selected character on the left side of the candidate character area 220, and then order additional candidate characters to the right in decreasing order of popularity.

A user may now enter the next categorical stroke group by moving the joystick 100, whereupon the process repeats. For example, category 116 might be chosen by moving the joystick to the East cardinal position in order to close the switch 117. By doing so, a representative stroke corresponding to category 116 may be displayed in the stroke display area 212.

If a user sees a matching candidate character in area 220, then it may be necessary to select that candidate character. Alternatively, the user may desire to begin searching a list of candidate characters, part of which is displayed in the candidate character area 220. While in the central cardinal position, coaxially pressing and then releasing the joystick 100 may close switch 101, which may signal the processor that the user desires to stop entering stroke categories, and may also signal to the processor that the user desires to enter the candidate character area in the navigational mode. When the switch 01 opens upon release of the joystick 100, the processor may highlight one of the candidate characters in the candidate character area 220. This highlighting may take any number of forms, including forms commonly found in the art, such as marking with a cursor, underlining, or reverse video to show the candidate marked as distinct from the others. In this description, we use the cursor to illustrate the invention, and it should be noted that the cursor may take many forms, and many are common in the art. Moving the joystick 100 to the East position closes switch 117 and may cause the cursor marking the candidate character to move to the adjacent character to the right. If the switch is held closed, the cursor may continue to move to the right through the list of candidate characters until the end of the list is reached. When the end of the character area 220 is reached by the cursor, the list may be scrolled. Similarly, if the joystick 100 is moved to the West position, then the cursor may be moved one character to the left and, if the switch 105 is held closed, the cursor may continue in this fashion until the beginning of the list is reached. If the cursor arrives at the desired character, the user may select that character by placing the joystick in the central cardinal position and coaxially pressing the joystick 100, thereby closing switch 101, whereupon the chosen character is moved to the next position 208 in the text area 200.

In an embodiment of the invention, while in the navigational mode, if the joystick 100 is moved South, thereby closing switch 109, the result may be that the candidate character list may be displayed in the text area 200. If the candidate character list is too long to be displayed in the text area 200, then portions of the candidate character list may be displayed in the text area 200 to better accommodate searching the list. For example, upon a first movement of the joystick 100 to the South, a first portion of the candidate character list may be displayed in the text area 200, and then upon a second movement of the joystick 100 to the South, a second portion of the candidate character list may be displayed in the text area 200. Further pressing of the joystick 100 to the South cardinal position while in the navigational mode may be used to display sequential sections of the candidate character list in a portion-by-portion fashion. For example, if the text area 200 can show six candidate characters, then moving the joystick 100 South may replace the first six candidate characters with a second six candidate characters. Subsequent movements of the joystick 100 to the South cardinal position will result in scrolling through the candidate character list toward an end of the list. If the joystick 100 is moved to the North cardinal position, thereby closing switch 113, the sets of candidate characters may be moved toward a beginning of the candidate character list. In this fashion, the user may scroll through the list in either direction.

When scrolling through the candidate character list, the highlighted candidate character may be that candidate that is in the position that the cursor was last established. So, if the third candidate character was highlighted before the joystick 100 was moved South, then when the new portion of the list is displayed in text area 200, the candidate character that occupies the third position will be highlighted. Moving the joystick 100 to the West cardinal position or the East cardinal position may index the cursor, left or right respectively, within a displayed portion of the list. If either end of the candidate character list is reached, the process may be paused until the user releases the joystick 100, thus opening all switches. If the user now selects North or South corresponding to the beginning or the end of the list, then the system may exit the navigational mode and reset to the categorical mode.

If the user holds coaxial pressure on the joystick 100 and then moves the joystick 100 to the West while in the categorical mode, so that both switches 101 and 105 are closed simultaneously, then the processor may interpret this as a signal to clear the previously entered stroke category. If done, the previously entered stroke category may be removed from the screen. Having done so, the user may then be allowed to enter a replacement stroke category.

In some implementations of the invention, it may be advantageous to allow the user to reverse an operation. This may be achieved by coaxially pressing the joystick 100 and moving the joystick 100 to the East so as to close both switches 101 and 117 simultaneously. This is referred to herein as the “redo” command. The total number of sequential redo commands may be limited by the memory allocated for this purpose. Having entered the redo command, the processor may return the display to the immediately prior state, and may allow the user to perform a replacement operation. For example, operations may include selecting a category or a character.

In an embodiment of the invention, the user may move to the text area 200 when the stroke display area 212 is clear by coaxially pressing the joystick 100 and moving the joystick 100 to the North cardinal position while holding coaxial pressure, thereby closing both switches 101 and 113. If strokes have been entered and the user wishes to move to the text area 200, the user may clear the strokes appearing in the display area 212, and then may be allowed to move into the text area 200.

Once in the text area 200, a cursor may be placed at the end of the text line and the user may move the cursor by displacing the joystick 100 to the North, South, East or West cardinal positions until a particular character appearing in the text area 200 is highlighted. To clear the highlighted character, the user may coaxially press the joystick 100 and move the joystick 100 to the West cardinal position. Coaxially pressing the joystick 100 and moving the joystick 100 to the East may replace the cleared character. Moving the joystick 100 to the South cardinal position while applying coaxial pressure may index the character to the end of the text line. If the user desires to begin entering strokes, he may remove the coaxial pressure and then move the joystick 100 to the South cardinal position, whereupon the processor may then return to the categorical mode.

Candidate characters displayed in the candidate character area 220 may be complete ideographic characters or they may be portions of characters, referred to herein as “components.” Components may be substructures which are found within complete characters. Because some characters are also components of more complex characters, such component-characters may be shown distinctly from and in addition to their complete character form by the manner of their display. If candidate characters and components are both displayed in the candidate character area 220, it may be necessary to distinguish components from candidate characters. For example, components appearing in the candidate character area 220 may be displayed in a different color, or may be displayed to appear smaller than characters that are selectable to the main text area 200.

If a user selects a component from the candidate character list, then the selected component need not be moved to the text area 200. Instead, the candidate character list may be updated to show only those characters which include the selected component. If the user selects a component, the stroke entry record appearing in the display area 212 may be modified to show the selected component in lieu of the stroke record previously displayed there. As an example, feature number 214 identifies a component character that resulted from entering stroke categories 108, 112, 116 and 116 in that order. Upon entering those four strokes, the component appeared in the candidate character area 220 and was selected by the user, which resulted in the component 214 being displayed in the stroke display area 212. Upon displaying the component 214 in the stroke display area 212, the strokes resulting from entering categories 108, 112, 116 and 116 were removed from the stroke display area 212.

For example, the user might have entered category 108 followed by category 112. The candidate character area 220 may display completed characters and components, including component-characters, having strokes corresponding to both category 108 and category 112. If the user selects, for example, one of the components displayed in the candidate character area 220, the processor may display the component in the stroke display area 212 and the processor may also display candidate characters having the selected component in candidate character area 220. The user may be allowed to search the new candidate character list and select to the text area 200 or may return to the stroke entry mode to append to the component now shown on the stroke display area 212.

The foregoing description is not limiting, and it should be recognized that there are many forms of indicator systems which may be used. For example, the actions exemplified above may be easily replicated using a trackball, rocker keys, a trackpad, position sensors, or potentiometers. Further, displays which are too small to accommodate simultaneous display areas 200, 212, 220 nevertheless can be used by creating a virtual display and then physically showing each or any combination of the areas 200, 212, 220 on the display.

The invention has been described herein with respect to an indicator system that is operable by a one finger. Embodiments of the invention may utilize an indicator system that is operable by other body parts. For example, if a person's eye movement is tracked, a person may indicate one of the cardinal states by causing his pupil to move in a particular direction. For example, the East cardinal state may be indicated by looking to the person's right. If the central cardinal state is desired, the person might look straight ahead, and if it is desired to close switch 101, the person might blink. Moving from one mode to another may be accomplished by rolling the eye or moving the eye rapidly left to right.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A text entry system, comprising:
a display visually divided into at least two functional areas, a first of the functional areas corresponding to a first aspect of entering text, and a second of the functional areas corresponding to a second aspect of entering text;
an indicator system operable by one human digit, the indicator system having at least a first cardinal state, a second cardinal state and a third cardinal state, the third cardinal state having no textual meaning associated with it;
a processor responsive to each cardinal state, whereby the indicator system may be used to select options displayed in at least one of the functional areas;
a program controlling the processor so that text may be entered in response to a user selecting at least one of the options.

2. The text entry system of claim 1, wherein:
the first cardinal state is activated by applying a force to a first location;
the second cardinal state is activated by applying a force to a second location; and
the third cardinal state is activated by identifying a third location, the third location being located between the first location and the second location.

3. The text entry system of claim 2, wherein a fourth cardinal state is activated by activating the first cardinal state and the third cardinal state.

4. The text entry system of claim 2, wherein identifying the third location is accomplished by applying a force to the third location.

5. The text entry system of claim 1, wherein the text entry system has a first mode and a second mode, wherein;
when the text entry system is in the first mode, the first cardinal state has a textual meaning associated with it, and
when the text entry system in the second mode, the first cardinal state has a different meaning associated with it.

6. The text entry system of claim 5, wherein the different meaning is a different textual meaning.

7. The text entry system of claim 5, wherein the different meaning is not a textual meaning.

8. The text entry system of claim 7, wherein the different meaning is a navigational meaning.

9. The text entry system of claim 5, wherein moving from the first mode to the second mode is accomplished by applying a force to the third location.

10. The text entry system of claim 5, wherein when the text entry system is in the first mode, the first cardinal state is used to select a first category of text and the second cardinal state is used to select a second category of text.

11. The text entry system of claim 1, wherein the first cardinal state is used to select a first category of text and the second cardinal state is used to select a second category of text.

12. The text entry system of claim 11, wherein the first cardinal state is used to select a first category of text and the second cardinal state is used to select a second category of text, wherein the first category of text includes symbols having a first feature and the second category of text includes symbols having a second feature.

13. The text entry system of claim 12, wherein a symbol having both the first feature and the second feature is included in both the first category and the second category.

14. The text entry system of claim 1, wherein the indicator system includes a position indicator and selection of one of the cardinal states is accomplished by detecting a position of the position indicator.

15. A method of entering text, comprising:
providing a display having a first functional area and a second functional area;
providing an indicator system operable by one human digit, the indicator system having a first cardinal state, a second cardinal state and a third cardinal state;
providing a processor operably connected to the indicator system;
activating the first cardinal state to indicate to the processor selection of a first category of text to be entered, the first category including symbols used to create a plurality of text characters.

16. The method of claim 15, further comprising displaying a representative symbol, the representative symbol corresponding to the first category.

17. The method of claim 15, further comprising displaying in the first functional area a text character having one of the symbols corresponding to the first category.

18. The method of claim 17, further comprising:
activating the second cardinal state to indicate to the processor selection of a second category of text to be entered, the second category including symbols used to create a plurality of text characters; and
displaying in the first functional area a text character having one of the symbols corresponding to the first category and one of the symbols corresponding to the second category.

19. The method of claim 17, further comprising selecting the text character displayed in the first functional area.

20. The method of claim 18, further comprising displaying the selected text character in the second functional area.

21. The method of claim 15, further comprising:
displaying in the first functional area a first icon that represents a text character which has one of the symbols corresponding to the first category; and
displaying in the first functional area a second icon that represents part of a text character, the first icon and the second icon having the same symbols.

22. A method of entering text, comprising:
providing a display having a first functional area and a second functional area;
providing an indicator system operable by a human eye, the indicator system having a first cardinal state, a second cardinal state and a third cardinal state;
providing a processor operably connected to the indicator system;
activating the first cardinal state to indicate to the processor selection of a first category of text to be entered, the first category including symbols used to create a plurality of text characters.

23. The method of claim 22, further comprising displaying a representative symbol, the representative symbol corresponding to the first category.

24. The method of claim 22, further comprising displaying in the first functional area a text character having one of the symbols corresponding to the first category.

25. The method of claim 24, further comprising:
activating the second cardinal state to indicate to the processor selection of a second category of text to be entered, the second category including symbols used to create a plurality of text characters; and
displaying in the first functional area a text character having one of the symbols corresponding to the first category and one of the symbols corresponding to the second category.

26. The method of claim 24, further comprising selecting the text character displayed in the first functional area.

27. The method of claim 26, further comprising displaying the selected text character in the second functional area.

28. The method of claim 22, further comprising:
displaying in the first functional area a first icon that represents a text character which has one of the symbols corresponding to the first category; and
displaying in the first functional area a second icon that represents part of a text character, the first icon and the second icon having the same symbols.
